(19) United States
(12) Patent Application Publication
(10) Pub. No.: US 2006/0261750 A1
(43) Pub. Date: Nov. 23, 2006

(54) Method and device for driving CCFL circuit

(75) Inventor: Ching-Chung Chang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Lite-On Technology Corporation

(21) Appl. No.: 11/245,517

(22) Filed: Oct. 7, 2005

(30) Foreign Application Priority Data
May 19, 2005 (CN) 200510073970.5

(51) Int. Cl. H05B 37/02

(52) U.S. Cl. 315/291

(57) ABSTRACT

A driving device for a CCFL circuit comprising at least one CCFL is provided. The driving device comprising at least one heating device controlling the temperature of the CCFL, a power supply outputting a first voltage, and a switching device having a first input terminal receiving the first voltage and a first and second output terminal; wherein the first output terminal is coupled to the CCFL circuit outputting a second voltage when the first voltage is higher than a first level, and the second output terminal is coupled to the heating device outputting a third voltage when the first voltage is lower than the first level. The driving device further comprises a controller controlling the power supply to output the first voltage higher than the first level to lighting up the CCFL, and lower than the first level to control the temperature of the CCFL.

### BACKGROUND

The invention relates to a cold cathode fluorescent lamp (CCFL) circuit and, more particularly, to devices for rapidly lighting a CCFL.

CCFL is a widely used light source in electronic devices such as scanners, LCD panels, notebook PCs and LCD televisions. Illumination of a conventional CCFL, however, may take up to 3 minutes to achieve stability after power up. FIG. 1 is a block diagram of a conventional electronic device 10 comprising a CCFL circuit. Electronic device 10 comprises a power supply 11 and a CCFL circuit 12 comprising at least one CCFL 121. Power supply 11 provides a voltage DC1 to the CCFL circuit 12. CCFL circuit 12 generates a high voltage AC supply according to the voltage DC1 to light CCFL 121.

A method to drive a CCFL is provided by Johnson, et al. (U.S. Pat. No. 5,907,742, “Lamp control scheme for rapid warm-up of fluorescent lamp in office equipment”). The lamp is over-driven with high current for up to a predetermined time limit to accelerate mercury vaporization. The drive current is then reduced to a normal level. Between each use, the lower lamp current is 40% of the normal level to keep the lamp warm while extending the life of the product.

Using Johnson's Method, a certain amount of power is required when the CCFL is not working to maintain the temperature of the CCFL. The power consumed at the lower lamp current state is significant and additional logic circuits are required for controlling current in different states. Furthermore, if a longer length CCFL is utilized in electronic device 10, to raise the current when lighting the CCFLs, the CCFL circuit 12 receives higher voltage DC1 and generates higher voltage AC power. Consequently, transformers used in CCFL circuit 12 may not be capable of sustaining such a high voltage and may need to be upgraded, which leads to additional manufacturing cost.

A driving device for a CCFL circuit comprising at least one CCFL is provided. The driving device comprises: at least one heating device controlling the temperature of the CCFL; a power supply outputting a first voltage; a switching device having a first input terminal receiving the first voltage and a first and second output terminal outputting a second and third voltage respectively. The first output terminal is coupled to the CCFL circuit to output the second voltage when the first voltage is higher than a first level. The second output terminal is coupled to the heating device to output the third voltage when the first voltage is lower than the first level. The driving device further comprises a controller controlling the power supply to output the first voltage higher than the first level to light the CCFL, and lower than the first level to control the temperature of the CCFL.

### DESCRIPTION OF THE DRAWINGS

The accompanying drawings, which are incorporated in and constitute a part of this specification, illustrate embodiments of the invention and, together with the description, serve to explain the features, advantages, and principles of the invention.

FIG. 1 is a block diagram of a conventional electronic device comprising a CCFL circuit.

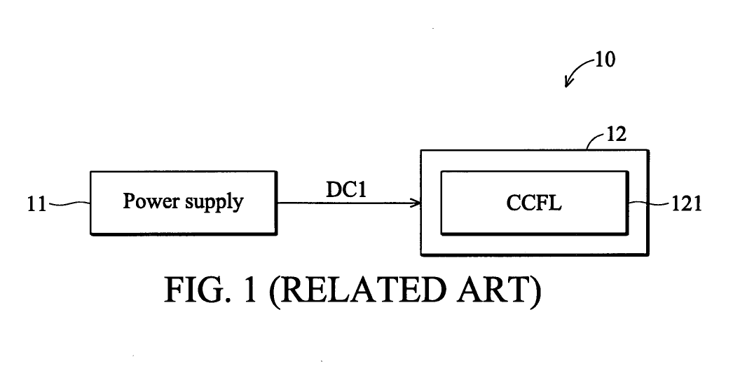

FIG. 2A is a block diagram of an electronic device according to an embodiment of the invention.

FIGS. 2B and 2C are block diagrams of different embodiments of the switching device of FIG. 2A.

### DETAILED DESCRIPTION

The invention provides a heating device maintaining the temperature of an idle CCFL, and enabling rapid lighting thereof.

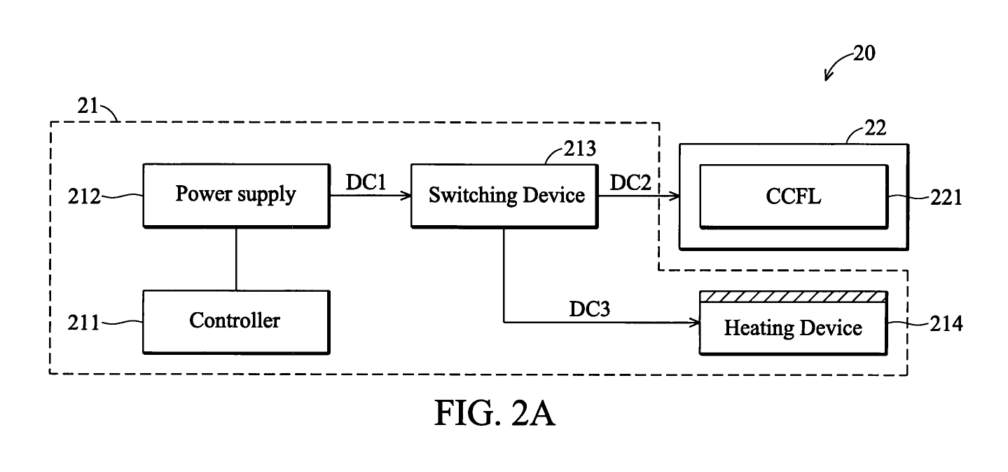

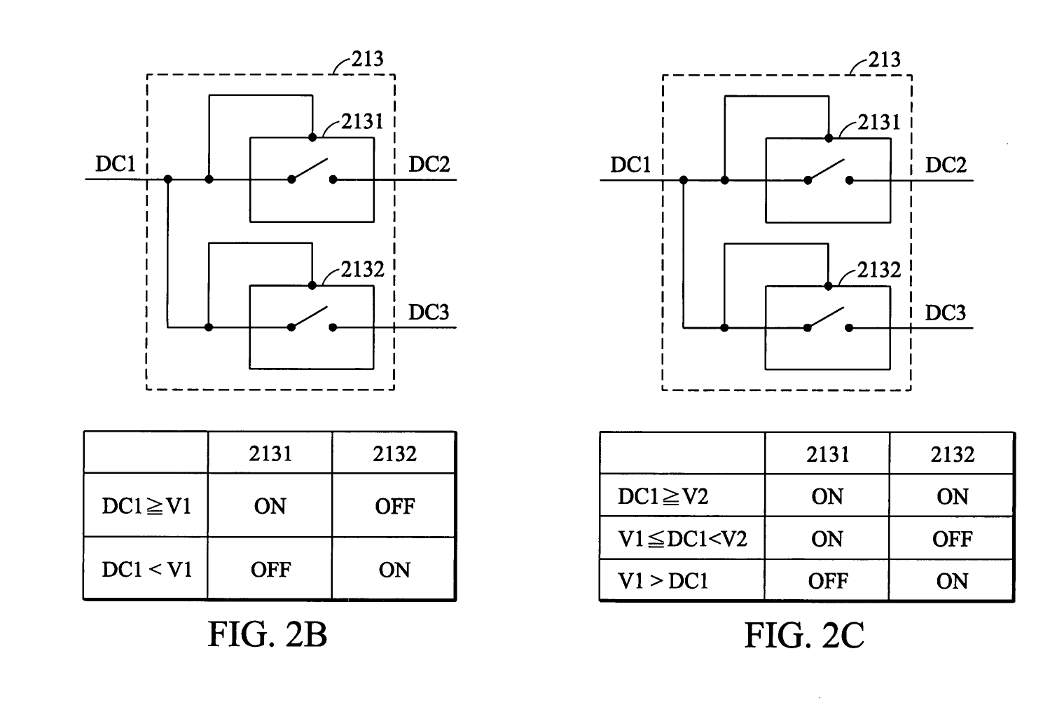

FIG. 2A is a block diagram of an electronic device 20 according to an embodiment of the invention. Electronic device 20 comprises CCFLs as a light source and may be a scanner, an LCD panel, a notebook PC or an LCD television, for example.

The electronic device 20 comprises a driving device 21 and a CCFL circuit 22 comprising at least one CCFL 221. Driving device 21 comprises a controller 211, a power supply 212, a switching device 213 and a heating device 214.

Power supply 212 outputs a first voltage DC1, controlled by the controller 221. Switching device 213 has a first input terminal receiving the first voltage DC1 and a first and second output terminal. The first output terminal is coupled to the CCFL circuit 22 outputting the second voltage DC2 when the first voltage DC1 is higher than a first level V1. The second output terminal is coupled to the heating device 214 outputting the third voltage DC3 when the first voltage DC1 is lower than the first level V1.

Controller 211 controls the power supply 212 to output the first voltage DC1 higher than the first level V1 to light the CCFL 211. Controller 211 controls the power supply 212 to output the first voltage DC1 and lower than the first level V1 to control the temperature of the CCFL 211 when the CCFL 211 is idle. The temperature of CCFL 211 is maintained, thus, the CCFL 211 can light rapidly when required.

FIG. 2B is a block diagram of an embodiment of the switching device 23 of FIG. 2A. Switching device comprise switching units 2131 and 2132. Switching unit 2131 is ON when the first voltage is higher than the first level V1, and is OFF when the first voltage is lower than the first level V1. Switching unit 2132 is OFF when the first voltage is higher than the first level V1, and is ON when the first voltage is lower than the first level V1.

In this embodiment, by controlling the first voltage DC1 to be lower than first level V1, CCFL 211 may be turned OFF when idle and the temperature thereof may be maintained. The CCFL 211 requires no power supply when idle and still be able to light rapidly when required next time.

A second level V2 higher than the first level V1 is provided for an extra function of this embodiment. The function of the first output terminal of switching device 23 remains the same. The second output terminal of switching device 23 outputs the third voltage DC3 when the first voltage DC1 is lower than the first level V1 or higher than the second level V2. In this embodiment, when the first voltage is higher than the second level V2, the CCFL is lit and the heating device 214 heats the CCFL 211. The temperature of the CCFL 211 may be increased rapidly and illumination of the CCFL 211 may rapidly reach the working illumination.

FIG. 2C is a block diagram of another embodiment of the switching device 23 of FIG. 2A. Switching device 23 comprises switching units 2131 and 2132. Switching unit 2131 is ON when the first voltage DC1 is higher than the first level V1, and is OFF when the first voltage is lower than the first level V1. Switching unit 2132 is OFF when the first voltage DC1 is between the first level V1 and the second level V2, and ON when the first voltage is lower than the first level V1 or higher than the second level V2.

In this embodiment, by controlling the first voltage DC1 to be higher than second level V2, CCFL 211 may be rapidly lit. By controlling the first voltage DC1 to be lower than the first level V1, CCFL 211 may be turned OFF when idle and the temperature thereof may be maintained. The CCFL 211 requires no power supply when idle and still be able to light rapidly when required.

The invention provides a compact design for a driving device of a CCFL circuit. A CCFL may be rapidly lit, consumes no power when idle, and is rapidly lit when required.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A driving device for a cold cathode fluorescent lamp (CCFL) circuit comprising at least one CCFL, comprising:
at least one heating device controlling the temperature of the CCFL;
a power supply outputting a first voltage;
a switching device having a first input terminal receiving the first voltage and a first and second output terminal outputting a second and third voltage respectively; wherein the first output terminal is coupled to the CCFL circuit and outputs the second voltage when the first voltage is higher than a first level, and the second output terminal is coupled to the heating device and outputs the third voltage when the first voltage is lower than the first level; and
a controller controlling the power supply to output the first voltage higher than the first level to light the CCFL, and lower than the first level to control the temperature of the CCFL.

2. The driving device as claimed in claim 1, wherein the switching device comprises a first switching unit coupled between the input terminal and the first output terminal, and a second switching unit coupled between the input terminal and the second output terminal; wherein the first and second switching unit is ON and OFF respectively when the first voltage is higher than the first level, and OFF and ON respectively when the first voltage is lower than the first level.

3. The driving device as claimed in claim 1, wherein:
the switching device further outputs both the second and third voltage when the first voltage is higher than a second level; wherein the second level is higher than the first level; and
the controller further controls the power supply to output the first voltage higher than the second level to rapidly light the CCFL.

4. The driving device as claimed in claim 1, wherein the switching device comprises a first switching unit coupled between the input terminal and the first output terminal, and a second switching unit coupled between the input terminal and the second output terminal; wherein the first switching unit is ON when the first voltage is higher than the first level, and is OFF when the first voltage is lower than the first level; and the second switching unit is ON when the first voltage is higher than the second level or lower than the first level, and is OFF when the first voltage is between the first and second level.

5. An electronic device comprising:
a CCFL circuit comprising at least one CCFL;
at least one heating device controlling the temperature of the CCFL;
a power supply outputting a first voltage;
a switching device having a first input terminal receiving the first voltage and a first and second output terminal outputting a second and third voltage respectively; wherein the first output terminal is coupled to the CCFL circuit and outputting the second voltage when the first voltage is higher than a first level, and the second output terminal is coupled to the heating device and outputting the third voltage when the first voltage is lower than the first level; and
a controller controlling the power supply to output the first voltage higher than the first level to lighting up the CCFL, and lower than the first level to control the temperature of the CCFL.

6. The electronic device as claimed in claim 5, wherein the switching device comprises a first switching unit coupled between the input terminal and the first output terminal, and a second switching unit coupled between the input terminal and the second output terminal; wherein the first and second switching unit is ON and OFF respectively when the first voltage is higher than the first level, and OFF and ON respectively when the first voltage is lower than the first level.

7. The electronic device as claimed in claim 5, wherein:
the switching device further outputs both the second and third voltage when the first voltage is higher than a second level; wherein the second level is higher than the first level; and
the controller further controls the power supply to output the first voltage higher than the second level to rapidly light the CCFL.

8. The electronic device as claimed in claim 7, wherein the switching device comprises a first switching unit coupled between the input terminal and the first output terminal, and a second switching unit coupled between the input terminal and the second output terminal; wherein the first switching unit is ON when the first voltage is higher than the first level, and is OFF when the first voltage is lower than the first level; and the second switching unit is ON when the first voltage is higher than the second level or lower than the first level, and is OFF when the first voltage is between the first and second level.

9. A method for driving a CCFL circuit comprising at least one CCFL, comprising:
providing a heating device controlling temperature of the CCFL;
providing a first voltage;
providing a second voltage to the CCFL circuit when the first voltage is higher than a first level; and
providing a third voltage to the heating device when the first voltage is lower than a first level.

10. The method as claimed in claim 9, further comprising:
Providing both the second and third voltage when the first voltage is higher than a second level, to light up the CCFL and heating the CCFL at the same time; wherein the second level is higher than the first level.
